(19) United States
(12) Patent Application Publication
(10) Pub. No.: US 2015/0144806 A1
(43) Pub. Date: May 28, 2015

(54) TWO-DIRECTIONAL SCANNING FOR LUMINESCENCE MICROSCOPY

(71) Applicant: Macquarie University, New South Wales (AU)

(72) Inventors: Dayong Jin, New South Wales (AU); Yiqing Lu, New South Wales (AU); James Austin Piper, New South Wales (AU)

(73) Assignee: Macquarie University, New South Wales (AU)

(21) Appl. No.: 14/401,103

(22) PCT Filed: May 28, 2013
(86) PCT No.: PCT/AU2013/000559

§ 371 Date: Nov. 13, 2014

(30) Foreign Application Priority Data
May 29, 2012 (AU) 2012902232

(51) Int. Cl. G01N 21/64

(52) U.S. Cl. CPC G01N 21/6458; G01N 21/6486; G01N 2201/10
USPC 250/461.2

(57) ABSTRACT

In one form, a two-directional scanning method for luminescence microscopy is disclosed. A series of continuous scans are performed by an interrogation wide-field relative to a first direction and a target is identified. A precise position of the target is determined in the first direction. At least one scan by the interrogation wide-field is performed relative to a second direction at or near the precise position of the target in the first direction. The two-directional scanning method produces “on-the-fly” (i.e. ex tempore or impromptu) precise localization of targets. Embodiments open up new applications for background-free or background-reduced luminescence microscopy, for example time-gated or time-resolved luminescence microscopy, in a relatively fast, higher speed or more efficient manner.

### TECHNICAL FIELD

The present invention generally relates to luminescence microscopy, for example fluorescence microscopy, and more particularly in various examples to interrogation of targets using wide-field, time-gated luminescence microscopy and/or time-resolved scanning, and also provides an analytical method, system and/or device in the example fields of biotechnology and life sciences.

### BACKGROUND

Fluorescence microscopy imaging techniques have been extensively used. Due to developments in fluorescent probes, numerous optical approaches have been developed to provide better resolution and sensitivity. One recent trend has been focused on further developing analytical contrast and speed. This is particularly important for a number of analytical fields of microbiology, disease diagnosis, and anti-bioterrorism, where there is increasing demand for relatively fast quantification of rare-event cells at low or reduced cost.

This, however, has proved extremely challenging to achieve. For example, rare-event detection is a challenge because the sample volume to be investigated is typically too large to obtain reliable detection events in a reasonably short time. In another example, event detection using spectral-discrimination of probe fluorescence is also a challenge, since one of the typical problems for an interrogation wide-field, e.g. electromagnetic radiation, incident on targets on or in a sample remains in that the intrinsic autofluorescence background obscures the visibility of fluorescence labelling due to the spectra overlapping. Reference to an ‘interrogation wide-field’ is generally understood as being when different objects are viewed or stimulated simultaneously, therefore also producing background effects, such as background fluorescence, and lowering the contrast. In fluorescence microscopy, the interrogation wide-field is electromagnetic radiation of a selected wavelength (or wavelengths) that produces a desired fluorescent effect in a target. Overall, it is very challenging to provide sufficiently sensitive detection of trace amount of targets from a large matrix of biological sample at a frequency of, for example, one in more than 100,000 background cells.

As an indicative example, the number of residual circulating tumor cells (CTCs) in peripheral blood is a valuable indicator for progressive diagnosis of metastatic cancer patients. A detection level of one residual cancer cell per 10⁷ bone marrow or peripheral blood stem cells is required. As another example, fetal cells present in maternal blood during pregnancy are an ideal source of genetic material for non-invasive prenatal diagnosis, however, the target fetal nucleated red blood cells (NRBCs) need to be detected against the maternal cells at extremely low frequencies of 1 in 10⁷ to 10⁹. As yet another example in water safety inspection, due to a very low number of some microorganisms being sufficient for infection, methods of analysis of water must be sufficiently sensitive to detect a single target microorganism (e.g. Cryptosporidium parvum and Giardia lamblia) in as many as 10 litres of water containing potentially millions of non-target microorganisms and particles.

This highlights a problem in being able to use luminescence techniques as bioimaging processes for a large volume of samples, and being able to produce satisfactory results in a relatively fast or efficient manner.

There is a need for a new or improved system, device and/or method that can be applied to or utilise luminescence techniques and/or probes, which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### SUMMARY

This Summary is provided to introduce a selection of concepts in a simplified form that are further described below in the Preferred Embodiments. This Summary is not intended to identify key features or essential features of the claimed subject matter, nor is it intended to be used to limit the scope of the claimed subject matter.

There is provided a system, device and/or method having general application to fluorescent/luminescent techniques and/or probes. In particular, but non-limiting, examples there are provided systems, devices and/or methods having example scanning applications in interrogation by a wide-field, time-gated, time-resolved and/or upconversion fluorescent/luminescent techniques and/or probes. The method can be a computer-implemented method.

In a particular form, a scanning method or process is used that provides relatively high-speed localization of targets, such as target microorganisms. For example, wide-field optical scanning, such as using a relatively large interrogation field or one or more photomultiplier tubes rather than point-by-point laser scanning, can be used to provide relatively high-speed localization of targets, such as target microorganisms.

According to a first example form, there is provided a two-directional scanning method for luminescence microscopy, including: performing a series of scans by an interrogation wide-field relative to a first direction and identifying a target; determining a precise position of the target in the first direction; and performing at least one scan by the interrogation wide-field, relative to a second direction, at or near the precise position of the target in the first direction.

In another example form, a scan or scans are made in a first direction and a target is identified, if present in the sample. An exact or precise position of the target in the first direction is obtained, determined or otherwise calculated. A rough or approximate position of the target in a second direction may also be optionally obtained, determined or otherwise calculated. Next, a scan or scans are made in or relative to a second direction, but focused (i.e. directed) at or near the target's more exactly or precisely known first direction position. This allows the scan or scans in or relative to the second direction to be limited or controlled to only scan or raster across the position of the target, or targets, thus providing a more efficient overall scanning method.

The two-directional scanning method produces “on-the-fly” (i.e. ex tempore or impromptu) exact or precise localization of targets. In a particular example using the method, cytometric analysis of lanthanide labelled Giardia cysts results in two order of magnitude improvement in sensitivity and speed. The method opens up new opportunities for background-free or background-reduced luminescence microscopy, for example wide-field, time-gated and/or time-resolved scanning luminescence microscopy, in a relatively fast, higher speed or more efficient manner.

In a particular, but non-limiting, form an approximate position of the target in the second direction is obtained by the series of scans by the interrogation wide-field relative to the first direction. In another example, determining the precise position of the target in the first direction is based on determining the positions where and/or the times when the target enters and exits the interrogation wide-field.

In another particular, but non-limiting, form a plurality of targets are identified at a number of precise positions in the first direction, and a series of scans by the interrogation wide-field are performed, relative to the second direction, passing through or near the number of precise positions of the targets in the first direction.

Optionally, the series of scans by the interrogation wide-field relative to a first direction are performed in a serpentine or raster pattern. Preferably, scans by the interrogation wide-field are continuous, or use a continuous motion during line section scans along the first direction and the second direction. Preferably, the target passes through the centre or near centre of the interrogation wide-field for the at least one scan by the interrogation wide-field relative to a second direction.

In particular example applications, relatively high contrast fluorescent/luminescent sensing techniques, such as time-gated luminescence (TGL) or time-resolved luminescence in the temporal domain, or upconversion luminescence in the spectral domain, can be used to further enhance rapid scanning due to the high-selectivity optical windows.

In another optional aspect, the two-directional scanning method is used with upconversion biolabels. The upconversion biolabels are able to be excited by near-infrared radiation as the interrogation wide-field, and the upconversion biolabels can produce visible multi-colour emissions.

In another optional aspect, the two-directional scanning method is used with a time-resolved luminescence scanning method. In this method, detection is of two or more targets with distinguishable lifetimes. In one preferred form, the time-resolved luminescence scanning method uses a Method of Successive Integration (MSI) algorithm to compute the lifetimes for individual targets in real time. Also, the time-resolved luminescence scanning method can use data binning to optimum computation speed. Preferably, a duration of a detection window is at least eight to ten times a lifetime of interest. In an optional aspect, a channel width is less than the lifetime of interest. In an example application, targets include DNA strands with different lifetime microspheres. Also preferably, the target is a luminescent probe or the like having a lifetime in the range of microseconds to milliseconds.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates an example two-directional scanning method to identify and localize targets of interest. (a) A sample is first examined in a first direction, such as in a serpentine or raster pattern, with continuous movement along the X-axis, to obtain precise X coordinates as well as rough Y coordinates for each target. (c) Then, the targets are scanned sequentially at respective X coordinates along the Y-axis to obtain precise Y coordinates. (b) and (d) illustrate overviews under an interrogation wide-field in the first direction and second direction scanning, respectively, representing the relative translation of a target particle across the interrogation wide-field.

FIG. 2 illustrates an example system or device on which the two-directional scanning method can be implemented.

FIG. 3 illustrates (a) how an example linear array detector can be used, and (b) to realise parallel detection by subdividing an interrogation wide-field.

FIG. 4 illustrates a further example system or device on which the two-directional scanning method can be implemented.

FIG. 5 illustrates a further example, system or device on which the two-directional scanning method can be implemented.

FIG. 6 shows the steps of an example two-directional scanning method.

FIG. 7 (a) illustrates a temporal waveform of an example time-gated luminescence (TGL) signal with a relatively-long detection time window, when a target is spatially scanned. One cycle is enlarged to illustrate the TGL detection technique: a pulsed excitation illuminates the interrogation field while a gating signal turns the detector off, leaving a delay period for residual excitation and autofluorescence to diminish. The long-lifetime TGL signal is recorded during the detection time window (recorded data plotted and fitted curve shown). The profile indicates the tendency in average intensity of luminescence decay. (b) Illustrates the real signal when the TGL cycle was compressed to 0.2 ms, along with its profile of average intensity. (c) Summarizes the histogram result of the TGL intensity from example 5-μm europium microspheres as targets.

FIG. 8 illustrates example kinematic data sets measured during continuous translations of an example motorized stage and corresponding example fitted curves.

FIG. 9 shows an example mapping result of one sample slide containing 24 potential Giardia cysts.

FIG. 10 shows bright-field and luminescence imaging of targets discovered on the sample slide, by retrieving spots on the example mapping result in FIG. 9, to confirm genuine Giardia cysts.

FIG. 11 illustrates the sensitivity of an example TGL scanning system or device. (a) Shows the number of artefacts on clean glass slide and clean quartz slide when varying the recording threshold of pulse area, indicating the detection limit on each substrate. (b) Shows a histogram summarizing the distribution of luminescence intensity from a total number of 854 example 1-μm Eu-containing microspheres prepared on seven quartz slides, with the area threshold set to 3.0 μV·s. (c) Shows an example mapping result of a quartz slide carrying 36 example 1-μm Eu microspheres, which were selectively arranged by flow cytometric sorting to form a “MQ” pattern. The example TGL scanning system or device was also used to analyse BHHCT-Eu chelate labelled Giardia cysts spiked onto normal glass slides. (d) Shows, from seven slide samples, a form of histogram the distribution of luminescence intensity from a total number of 920 labelled Giardia cysts. The great contrast between the events and the threshold is evidence that the system is free of false-negatives. (e) Shows confirmation of a discovered Giardia cyst after its location was retrieved (scale=50 μm; CCD camera exposure time of 150 ms for luminescence imaging, 8 ms for bright-field imaging).

FIG. 12 shows a schematic diagram of an example method and system for time-resolved scanning cytometry, which can identify targets randomly distributed on a slide and distinguish the targets by individual targets' luminescent lifetimes. (a) The targets are mapped in background-free condition via UV LED pulsed excitation and time-gated luminescence detection in anti-phase. The signal trains of luminescence intensity recorded from the detection field-of-view during the transit of the targets are used to obtain their precise locations along the continuous scanning direction. (b) The positional coordinates guide sequential orthogonal scans for spot-by-spot inspection of targets at the centre or near centre of the field-of-view (e.g. of a wide-field), and the luminescence lifetime identity of each target can be decoded in real-time.

FIG. 13 illustrates an example of the relative Cramér-Rao Lower Bound for the lifetime, CRLB(τ)/τ², normalized by the average number of photons, EN, as a function of MT/τ for different detection channel configurations. T is the width of every detection channel and M is the total number of detection channels, so that MT indicates the entire length of the detection window.

FIG. 14 illustrates example numeric simulation results for lifetime fitting algorithms. (a) Shows the relative variance of lifetime estimators, var(\hat{τ})/τ², normalized by the average number of photons, EN, as a function of MT/τ for different fitting algorithms with and without background taken into account, alongside the CRLB. (b) Comparison between MSI and MLE-PR methods in terms of accuracy (error bars stand for ±1 standard deviation) and computation speed, at different channel numbers as a result of data binning pretreatment.

FIG. 15 illustrates relative variance of lifetime estimators, var(\hat{τ})/τ², normalized by the average number of photons, EN, as a function of MT/τ for different fitting algorithms, when a high background noise was included in the numeric simulation (ten times higher than the background noise used for FIG. 14a).

### PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

### Scanning Method and Device

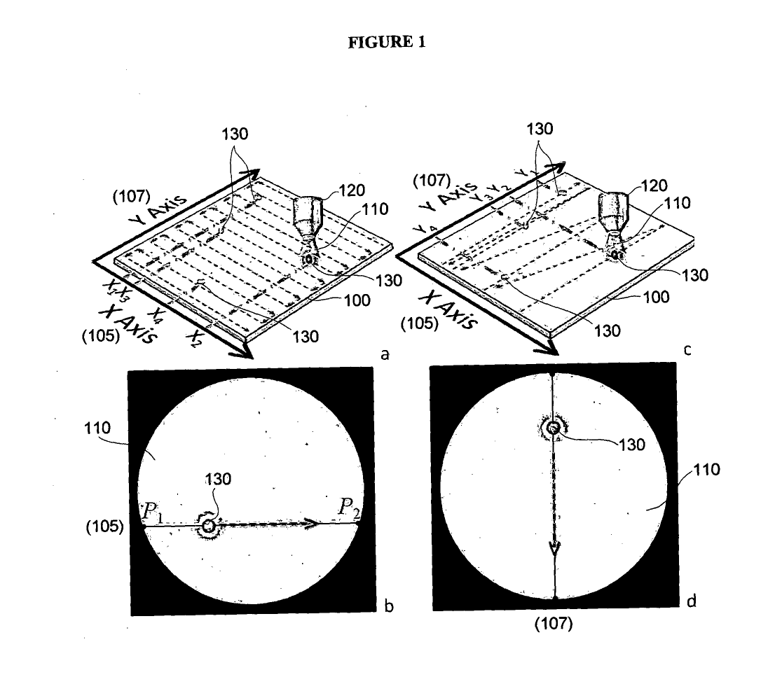

FIG. 1 illustrates a new two-directional scanning method, and associated system or device, for rapid detection and exact or precise localization of one or more targets, for example one or more target microorganisms. In this particular example, there is illustrated a two-directional orthogonal scanning method, however, it should be noted that the different directions of scans, lines or rasters need not necessarily be orthogonal. Coordinate systems other than a Cartesian coordinate system can be used, such as polar coordinates, cylindrical coordinates or spherical coordinates. That is, the first direction and the second direction can be part of a Cartesian coordinate system, a polar coordinate system, a cylindrical coordinate system or a spherical coordinate system. Also, it should be noted that the two-directional scanning method works for a variety of general target scanning techniques, for example, normal fluorescence detection on a solid-phase slide.

In particular, but non-limiting, examples the two-directional scanning method provides advantages when applied to relatively high contrast fluorescent/luminescent sensing techniques, such as time-gated luminescence (TGL) in the temporal domain, or upconversion luminescence in the spectral domain. In a non-limiting example, application to time-gated luminescence (TGL) operation is advantageous, since the epi-fluorescence optics in a TGL mode or system renders autofluorescence and excitation scattering invisible and only rare-event targets (for example microorganisms of interest) in a wide-field indicate positive to the detection system.

In an example two-directional scanning method, a detection event, such as a pulse profile/fingerprint of a target, obtained relative to a first or primary scan axis, is utilised to precisely bring a single target (e.g. a microorganism) into or near the central position in the wide-field for a second or subsequent scan axis, so that the optimal, or at least an improved, coefficient variation (CV) in intensity is enabled or obtained.

Referring to FIG. 1a, sample slide 100, or other form of substrate, is first scanned by an interrogation wide-field 110 (electromagnetic radiation of a selected wavelength or wavelengths) in a serpentine, raster or similar stepped pattern with each continuous motion along a first direction 105, in this example being the X-axis. A line scan is made along the X-axis, in either parallel direction, then a step is made along the Y-axis (in a positive or negative direction), then another continuous line scan is made along the X-axis, and this process is repeated. A variety of mechanisms, such as a motorized stage or stages, can be used to move sample slide 100 relative to objective 120 (i.e. the optical element that gathers light), to move objective 120 relative to sample slide 100, or to move both sample slide 100 and objective 120 relative to each other. The interrogation wide-field is of larger diameter or extent than a characteristic dimension size of the target.

The first direction 105 of scanning is used to identify one or more targets 130. In the illustrative example of FIG. 1a, four targets 130 have been identified at precise or accurate positions x, which in time order of identification are labelled as positions x₁, x₂, x₃ and x₄. In consideration of the “accelerating-decelerating” of a motorized stage along the X-axis, a kinematical calibration can be applied to precisely calculate the X coordinate value from detector pulse trains. This first direction step of the two-directional scanning method also records the rough or approximate position along the Y-axis given by a sequential index of adjacent lines.

Referring to FIG. 1b, generally a target 130 does not often appear at the exact centre of the wide-field 110 when scanning in the first direction 105. For the second direction 107 of the two-directional scanning method, scans or rasters relative to sample slide 100 with continuous motion, such as continuous motion along a line section, along a second direction 107, in this example the Y-axis, uses Y-axis scanning that is more spatially selective. Referring to FIG. 1c, Y-axis scanning uses the accurately known positions x₁, x₂, x₃ and x₄ of positive events from the first direction 105 of scanning along the X-axis. Referring to FIG. 1d, as the X-axis coordinate (x₁, x₂, x₃ and x₄) of targets 130 is precisely known or calculated, each Y-axis continuous motion scan or line can be well controlled to scan or raster across the position of targets 130 (on the wide-field centre). For the second direction scanning, a target 130 appears at or near the centre axis of the wide-field 110 when scanning in the second direction 107. It should also be noted that according to certain embodiments the X-axis and/or Y-axis scans need not necessarily be continuous, for example stepped motions of a suitable spatial resolution could be utilized. This then also precisely identifies target positions in the second direction 107, labelled as positions y₁, y₂, y₃ and y₄.

Thus in one form the target passes through the centre or near centre of the interrogation wide-field for the scan by the interrogation wide-field relative to the second direction, during which a luminescence intensity signal can be obtained for the target, on which subsequent analysis is to be based as this signal is more accurate or intense. Determining the precise position of the target in the first direction can be based on determining the positions where the target enters and exits the interrogation wide-field, by for example finding the midpoint between the entry and exit positions. Alternatively or additionally, determining the precise position of the target in the first direction could be based on determining the times when the target enters and exits the interrogation wide-field, and then correlating, times to positions. Also, determining the precise position of the target in the first direction could be based on a luminescence intensity signal of the target during the series of scans relative to the first direction, for example by assuming the maximum signal correlates to the position of the target in the first direction.

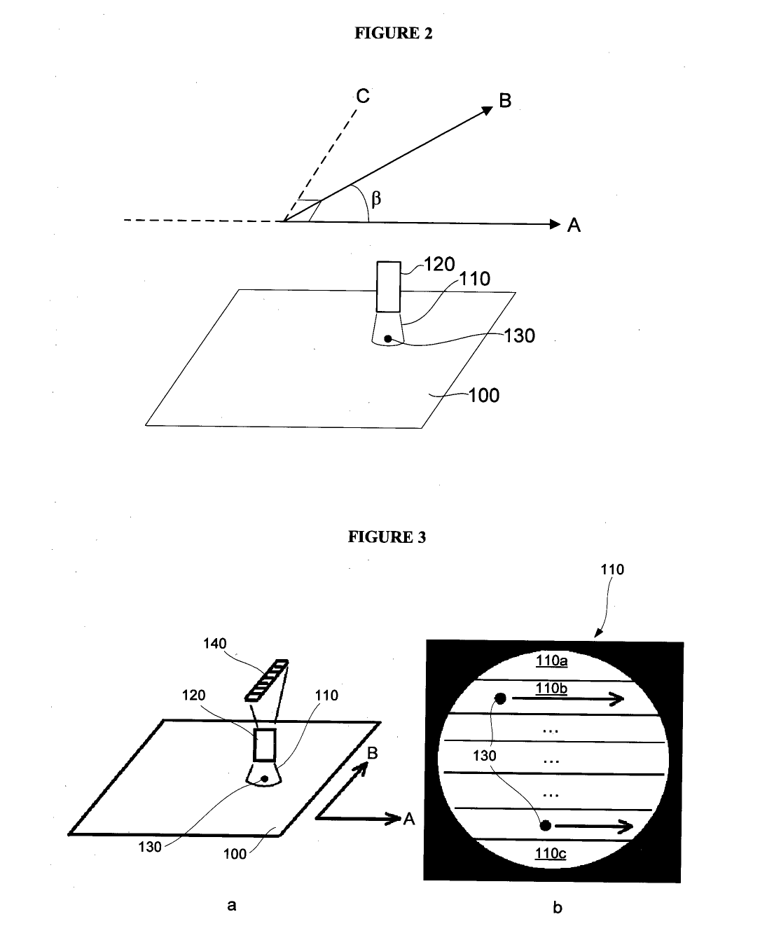

Referring to FIG. 2, in other example embodiments the separate scans of the first direction, along axis ‘A’, and the second direction, along axis ‘B’, could use a linear coordinate system with axes A and B oriented at angle β relative to each other, rather than at or about 90°, where angle β can be a range of angles. When β=90°, axis ‘B’ is located at position ‘C’ and the scans are orthogonal. For example, the directions of the separate scans could be angled anywhere between 1°<β<179° relative to each other, although between about 45°<β<135° is preferable. Thus, angle β can be set or predetermined so that substrate 100 is first scanned by interrogation wide-field 110 in a first direction ‘A’, as substrate 100 is moved relative to objective 120. After identification of target 130, substrate 100 is then scanned by interrogation wide-field 110 in a second direction ‘B’, as substrate 100 is moved relative to objective 120, but in a more limited spatial range depending on the identified position of the target 130 with respect to the first direction ‘A’.

Referring to FIG. 3a, there is illustrated a two-directional scanning method as discussed for FIG. 1 or FIG. 2, with the additional feature of a linear array detector 140 that can be used with objective 120. Referring to FIG. 3b, this allows parallel detection of targets 130 to be realised by subdividing the interrogation wide-field 110, for example into sections 110a, 110b, . . . , 110c as illustrated, which not only reduces the required processing time but also increases the spatial resolution. Thus, more than one target can be simultaneously detected by subdividing the interrogation wide-field into sections. For example, a multi-channel (e.g. 32-channel) photomultiplier tube can be used as the linear array detector 140 to expand or further improve on a single channel detector, as presented in FIG. 1, for improved scanning resolution.

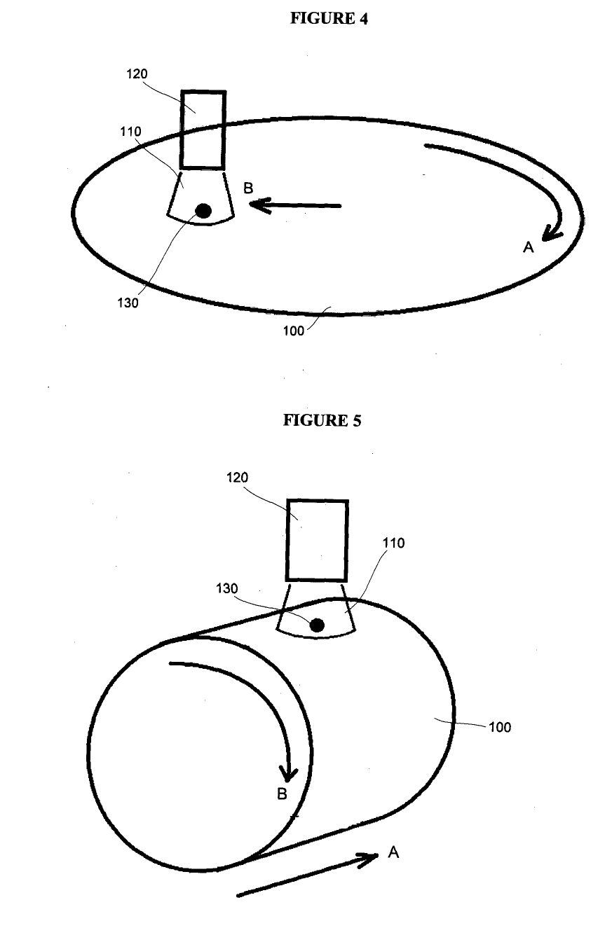

Referring to FIG. 4, in another example embodiment separate scans of the first direction, along an angular direction ‘A’, and the second direction, along a radial direction ‘B’, could be used to provide polar coordinates, so as to identify one or more targets 130 having angular coordinates and radial coordinates. Objective 120 and/or substrate 100 can be moved relative to each other, for example by objective 120 moving in a circularly stepped, or spiral, pattern about substrate 100. For clarity, it should be noted that, alternatively, the first direction could be a series of scans along different radial directions ‘B’ and the second direction along angular direction ‘A’.

Referring to FIG. 5, in another example embodiment separate scans of the first direction, along a height or length direction ‘A’, and the second direction, along an angular direction ‘B’, could be used to provide cylindrical coordinates, so as to identify one or more targets 130 having angular coordinates and height or length coordinates on a cylindrical surface. Objective 120 and/or substrate 100 can be moved relative to each other, for example by objective 120 moving in a lengthwise pattern along substrate 100 and substrate 100 rotating in an angular stepped manner under objective 120. For clarity, it should be noted that, alternatively, the first direction could be for the substrate 100 to rotate in angular directions ‘B’ under objective 120 and the second direction to be lengthwise scans along direction ‘A’.

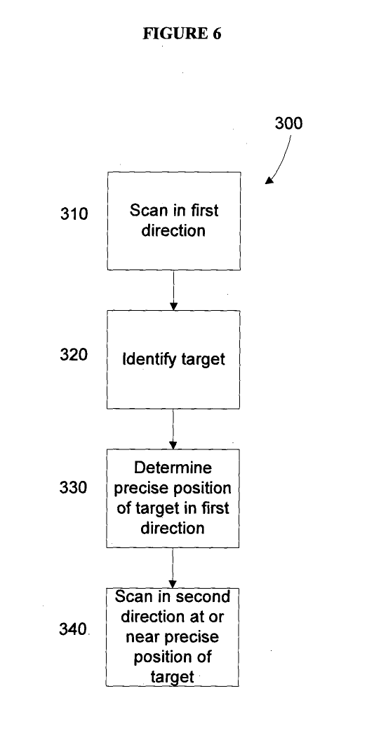

Referring to FIG. 6, there is illustrated a two-directional scanning method 300. At step 310, a scan or scans are made in a first direction, for example along an X-axis or an A-axis. At step 320, a target is identified, if present in the sample. At step 330, the precise, accurate or exact position of the target in the first direction is obtained, determined or otherwise calculated. At step 340, a scan or scans are made in the second direction, spatially limited to or near, focused at or near, or in the vicinity of, the target's more precisely, accurately or exactly known first direction position. It is also possible, but optional, to only scan a target near a rough or approximate position of the target in the second direction that can also be obtained, determined or calculated at step 330, rather than continuously along a line in the second direction. This allows the scan or scans in the second direction to be limited or controlled to only scan or raster across the precise position of the target or targets, thus providing a more efficient overall scanning method.

This provides a two-directional scanning method, in a preferred example for luminescence microscopy, that produces “on-the-fly” (i.e. ex tempore or impromptu) precise localization of targets.

Embodiments of the present invention advantageously use wide-field radiation to interrogate a relatively large area of the sample, relative to the size of a target, at any one time during scanning. It should be appreciated that this is very distinct to using highly focused radiation for interrogation of a target. By using novel scanning control methods as discussed herein, fluorescent targets can be discovered and their locations rapidly identified during wide-field scanning without being limited by a specific design of a scanner. The scanning methods can be generally applied in any form of scanner compatible with wide-field excitation, and detection, including the ability to locate targets during acceleration and/or deceleration of the sample or the objective during movement.

The use of wide-field and preferably continuous scanning provides advantageous features, for example including:

i. Processing a much larger area in a given time compared to spot scanning if the translation speed is the same (as well as wide-field step-by-step scanning). Overall, the present method is faster.

ii. Enabling time-gated detection, in which the excitation source and the detector are switched on/off in turns. This allows the use of long-lifetime luminescent probes, which offers ultra-sensitive detection free of optical background.

iii. The entire luminescence decay profiles of individual targets can be recorded during wide-field scanning. This offers new opportunities to use different decay lifetimes for target discrimination.

### Further Examples

The following examples provide a more detailed discussion of particular example embodiments. The examples are intended to be merely illustrative and not limiting to the scope of the present invention.

### Time-Gated Luminescence (TGL)

The time-gated luminescence (TGL) technique can be used to discriminate between long-lifetime luminescence labelled targets and autofluorescence background in the temporal domain. The TGL technique switches detectors at a few μs delay from the pulsed excitation switching-off, so that only the long-lived luminescence labelled targets remain for background-free detection. Thus, this option includes switching on a detector at a delayed time from switching off the interrogation wide-field, or signal controlling the interrogation wide-field, that is pulsed. The method of time-gated detection of long-lifetime (for example 1 to 2,000 μs) luminescence-labelled microorganisms following rapid excitation pulses has proved highly efficient in suppressing non-target autofluorescence (for example <0.1 μs) scatterings, and other prompt stray light.

Presently, a broad spectrum of long-lifetime luminescence bioprobes and upconversion bioprobes is available in forms of both metal chelate complexes and nanoparticles, for example lanthanide, phosphorescence and charge transfer materials. Both discrimination opportunities have been demonstrated for molecular assays and bioimaging. There are also available other techniques providing high-contrast signal-to-background ratios, for example polarization based discrimination methods.

In a particular example, there is provided a two-directional scanning method applied to time-gated luminescence microscopy. As an indicative example, in one form the two-directional scanning method produces “on-the-fly” (i.e. ex tempore or impromptu) precise localization of targets, for example about 1 μm lanthanide microspheres, with a signal-to-background ratio (SBR) of 8.9. In one example embodiment, the method takes about three minutes to statistically analyze a slide of 15×15 mm². In a particular example, an LED excited prototype system only requires hundreds of photoelectrons within 100 μs to distinguish target events. In a particular example using the method, cytometric analysis of lanthanide labelled Giardia cysts results in two order of magnitude improved SBR. This novel method opens up new opportunities for background-free or background-reduced time-gated luminescence microscopy in a relatively fast, higher speed or more efficient manner.

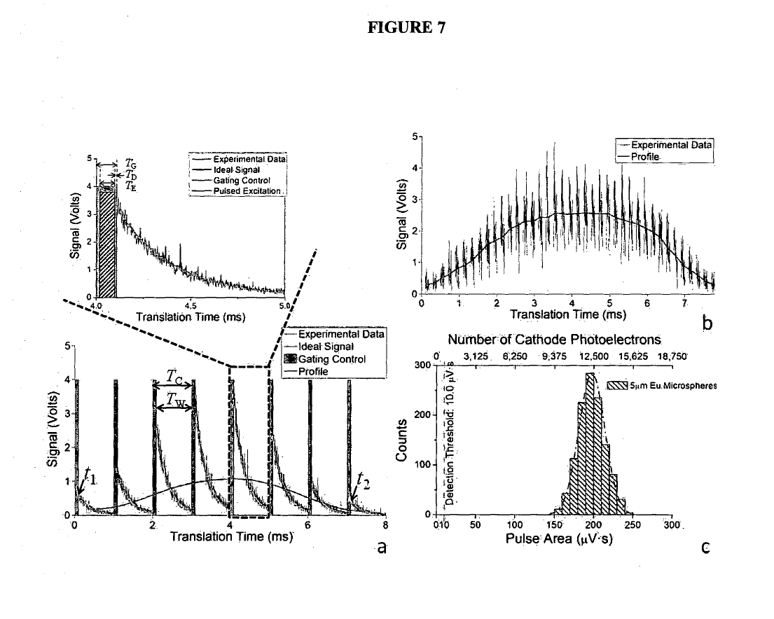

FIG. 7 illustrates a real time “on-the-fly” (i.e. ex tempore or impromptu) example scan along the X-axis for the scanning method illustrated in FIG. 1. In the time-delayed detection phase, the prolonged decay from targets with long-lived luminescence (in this example 5 μm europium FireRed™ microsphere from Newport Instruments) is outstandingly clean from the prompt decay of autofluorescence and excitation. As a result, when a target enters the interrogation field, the target's luminescence signal is recorded until it exits the field. The stored signal train (FIG. 7a) displays the sunrise-sunset profile to derive the position and the intensity level of the target. Denoting the beginning of the collection window in the first TGL cycle as t₁ (FIG. 7a), and the position and the corresponding time the target enters the interrogation field as P₁ and t(P₁) (FIG. 1b), it can be inferred that:

t₁−T_{D}−T_{C}<t(P₁)≦t₁−T_{D} (1)

Here, T_{C} denotes the duration of TGL cycle, and T_{D} denotes the delay time between the end of excitation and the beginning of collection. Inequality (1) follows because the target enters the interrogation field before the excitation pulse in the first cycle is switched off, while after the last pulsed excitation; otherwise, the first signal cycle recorded would be either the next one or the last one. Similarly, regarding the exit of the target from the interrogation field, it is given that:

t₂≦t(P₂)<t₂+T_{C} (2)

In inequality (2), t₂ denotes the beginning of the collection window in the last recorded TGL cycle (FIG. 7a), while t(P₂) denotes the time the target exits the interrogation field (FIG. 1b).

In order to increase the temporal-to-spatial resolution, a high-repetition TGL rate (for example about 5 kHz) can be employed (FIG. 7b). This leads to a decreased T_{C}, and consequently T_{D}, which means t(P₁) and t(P₂) approach t₁ and t₂, respectively, according to inequality (1) and (2). In other words, the period a target passes across the interrogation field can be represented pseudo-continuously by means of its recorded signal, given the duration of the TGL cycle is sufficiently short (FIG. 7b). When each target spends several TGL cycles in the wide-field optics, the difference (profile) in signal intensity between adjacent cycles reflected optics (excitation and signal collection) efficiency changes, which clearly indicates the enter→exit transaction (P₁→P₂) of a target, such as the microsphere in this example, relevant to the optics. This provides an opportunity to calculate the precise position of the target, for example on a slide, on or in a container, or other form of substrate or holding vessel, based on kinematics. This approach can also be used to ensure the target(s) should pass over or under the centre, or near centre, of wide-field optics (i.e. interrogation field) during the second direction scanning process, such as along the Y-axis, where the luminescence intensity of the target(s) is acquired under identical conditions.

### Example System/Device

In a non-limiting example, and referring again to FIG. 2, a motorized stage (such as the H101A model from Prior Scientific having a maximal translation velocity vₘ=24 mm/s) was implemented to mobilise a loaded sample 100 across an epi-fluorescent microscopic viewing field 110. The luminescence collected by objective 120 (such as Stock No. NT38-340 from Edmund Optics, 60×, NA=0.85) was acquired by a photo-multiplier tube (PMT) capable of gating electronically (such as the H10304-20-NF model from Hamamatsu, Cathode Radiant Responsivity R=75 mA/W at λ=620 nm, Electron Amplification Gain GE=106 at 0.9 Volts control voltage). The excitation source was an ultraviolet light-emitting diode (UV-LED) with peak wavelength at 365 nm (such as the NCCU033A model from Nichia, 250 mW at 500 mA continuous injection current), of which the purpose built driving current supply was synchronized with the PMT via a digital delay/pulse generator (such as the DG535 model from Stanford Research Systems) to perform TGL detection. Optionally, a multifunction data-acquisition card or purpose-built integrated circuit could also be used.

For all experiments, the period of the TGL cycle TC was set to 200 μs, yielding a largest displacement (=vₘT_{C}) of 4.8 μm per TGL cycle for the motorized stage, which was also the maximal locating error for targets. Since long-lifetime probes typically have lower levels of luminescence intensity than conventional probes, they require stronger excitation to saturate potential energy states for radiative relaxation and longer time window to collect emitted photons. To balance the demands from both sides, the duty ratio of TGL cycle was fixed to 50%, generating 100 μs for both the gating period (T_{G}) and the signal collection window (T_{W}). The excitation source was switched on for T_{E}=80 μs during the gating period with the delay period T_{D} set to 5 μs.

The output current signal of the gatable PMT was further converted to a voltage signal via a low noise current amplifier (for example using the DLPCA-200 from FEMTO) with a transimpedance gain of G_{T}=105 Volts/Amp. The amplified signal, together with the gating control applied on the PMT, were collected at a sampling rate of 500k samples/second/channel into two analog input channels of a PC-based data-acquisition card (for example the PCI-6251 card from National Instruments) through a BNC adapter (for example the BNC-2110 adapter from National Instruments). The same PC was used to send commands to the motorized stage controller (for example the H129 controller from Prior Scientific), in order to simultaneously trigger data collection of the signals and translation of the stage. The TGL signals in each cycle are summated (discrete equivalence of integration) after sampling to calculate “Area” values A, which represent the luminescence intensity of the targets. Only TGL cycles with area values exceeding a prearranged area threshold A_{T} were recorded, in case a large amount of data caused an overflow of computer memory.

The optical elements utilised in the example system/device included: a dichroic filter (for example the 400DCLP filter from Chroma) to construct the epi-fluorescent structure; a fused silica condenser (f=30 mm, d=25 mm) to collimate the excitation beam; a UV-band-pass filter (for example the UG5 filter from SCHOTT, or the UG1 filter) to purify the excitation; a visible-band-pass filter (for example the 9514-B filter from New Focus, 30-nm FWHM band at 624 nm) to purify the emission; and a convex lens (f=40 mm, d=25 mm) to focus the emission into the PMT's photocathode window. In addition, a 45° mirror can be inserted into the optical path to reflect the emission to a CCD camera (for example the DS-Vi1 camera from Nikon, having 2 mega pixels) for image confirmation of the targets.

A particular embodiment can be realised using a processing system, or one or more processing systems, to perform necessary calculations, such as one or more general computers, computing systems or a dedicated microprocessors. The computer or processing system would generally include at least one processor, or processing unit or plurality of processors, memory, at least one input device and at least one output device, typically coupled together via a bus or group of buses. An interface can also be provided for coupling the processing system to one or more peripheral devices, for example an output signal associated with substrate 100 or optics 120. At least one storage device which houses at least one database can also be provided. The memory can be any form of memory device, for example, volatile or non-volatile memory, solid state storage devices, magnetic devices, etc. The processor could include more than one distinct processing device, for example to handle different functions within the processing system.

TABLE 1
Example scanning results of sample slides containing 1-μm
Eu microspheres prepared by flow sorting.

| Slide | Events | Detection | Targets | Beads |
|---|---|---|---|---|
| No. | Sorted | Threshold (μV · s) | Discovered | Confirmed |
| 1 | 36 | 3.00 | 34 | 34 |
| 2 | 36 | 3.00 | 37 | 37 |
| 3 | 36 | 3.00 | 33 | 33 |
| 4 | 36 | 3.00 | 37 | 37 |
| 5 | 36 | 3.00 | 36 | 36 |
| 6 | 36 | 3.00 | 38 | 38 |
| 7 | 36 | 3.00 | 34 | 34 |
| 8 | 36 | 3.00 | 36 | 36 |
| 9 | 36 | 3.00 | 37 | 37 |
| 10 | 36 | 3.00 | 33 | 33 |
| Slide | Pulse Area of Targets (μV · s) | | | |
| No. | Minimum | Average | Maximum | |
| 1 | 9.57 | 12.42 | 17.15 | |
| 2 | 11.48 | 21.20 | 30.90 | |
| 3 | 10.07 | 15.16 | 22.82 | |
| 4 | 9.93 | 22.82 | 33.21 | |
| 5 | 11.22 | 21.42 | 27.71 | |
| 6 | 11.39 | 19.08 | 28.26 | |
| 7 | 8.92 | 11.21 | 13.98 | |
| 8 | 12.14 | 22.24 | 33.22 | |
| 9 | 9.91 | 18.39 | 31.01 | |
| 10 | 11.58 | 17.39 | 23.71 | |

### Kinematics for Localization of Targets

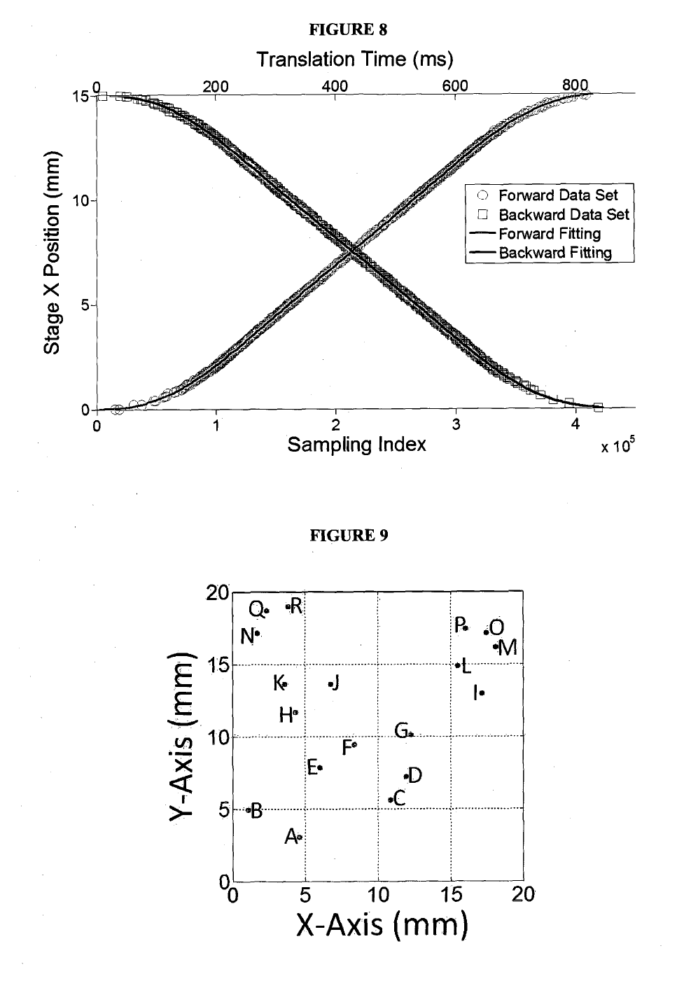

In the example system/device presented above, instead of moving the interrogation field 110 across the sample, which is an alternate option, the optical path was fixed, and the sample 100 was loaded on a motorized stage to translate relative to the interrogation field 110. Thereby, the kinematics in the scanning system only involves translation of the motorized stage. This requires either calibration in advance, or to be monitored in real-time, for the purpose of calculating the spatial position of the target(s) from temporal sequences of luminescence signal. The latter requires feedback devices such as linear encoders, which potentially increase the complexity and the cost of the system/device. In the example system/device, the displacement versus time relations of the motorized stage for fixed-distance translations were measured in both directions along continuous scanning axis, and fitted to 7th degree polynomial functions prior to the scanning (see FIG. 8). The coefficient of determination R-squares were computed beyond 0.9999 using a computer or other processing system.

The data collection of the luminescent intensity signal, as well as the gating control signal, was synchronized with each single continuous translation of the motorized stage. Since the sampling rate is constant, the indices of the temporal sequences correspond by a factor of sampling period (reciprocal of the sampling rate) to the translation time of the stage, which can be mathematically converted to its position according to the fitted polynomial functions. In particular, the beginning of the collection window in the first and the last recorded TGL cycle (t₁ and t₂) was used as the time the target enters and exits the interrogation field (t(P₁) and t(P₂)) to calculate the entrance and exit positions (P₁ and P₂). Hence, the middle position between them is where the target is closest to the centre of the interrogation field within the scanned line. Therefore, successive scans, such as orthogonal scans, can be used to provide precise coordinates of a target in both directions.

In theory, the precision of target location and intensity measurement should only rely on the translation displacement within a single TGL cycle, which was 4.8 μm according to the example system configuration used. In practice, several other factors have been observed to affect spatial and intensity precision. Firstly, the variance in focal distances of each target tailors the target's luminescence collection, even the sample-loading plate has been adjusted to be perfectly perpendicular to the optical path. Applying spin-coating to prepare the specimen slides helps alleviate this effect. Secondly, there are irregular jitters in the synchronization between the commencements of stage translation and data collection, causing random errors in computing locations of the targets. It may be suggested to monitor the kinematics in real-time by linear encoders instead of pre-calibration, so that any jitter is also recorded for deduction. Furthermore, the signal-to-background ratio apparently has influence on any accurate measurement. Efforts to improve the signal as well as suppress the background from optical, electronic, and biochemical aspects will assist.

### Uniformity in Measuring Luminescence Intensity

As is seen in FIGS. 7a and 7b, the maximum in the average profile indicates a moment the target exhibits highest luminescent intensity, as a combined effect of both excitation power and photon-collection efficiency, in the particular line along which it is scanned. It is evident that the same particle, or particles with identical energy structures, will emit different amounts of irradiance if placed in different positions within the interrogation field. Assuming both factors, the excitation irradiance and the emission-collection efficiency, undergo circular symmetry, with values maximized at the centre of the interrogation field and reduced as the particle moves away from the centre. Thus, the combined effect increases as the distance from the target to the centre of the interrogation field decreases. If we use a scalar r to denote the distance from the particle to the centre, α(r) as the distribution of the combined coefficient, we will have:

0≦α(r₁)<α(r₂)≦1;

∀r₁,r₂ε[0,R_{F}],r₁>r₂ (3)

Here, R_{F} denotes the radius of the interrogation field.

α(r) is an attenuation factor modifying the collected luminescent intensity relative to the peak value at the centre. Hence, in general, the distribution of collected luminescence intensity of targets may greatly deviate from the intrinsic distribution. Provided the probability density functions of the former and the latter represented as f′(i) and f(i), it can be concluded that:

$${f}^{′} ( i ) = {\int }_{0}^{{R}_{F}} f ( \frac{i}{α ( r )} ) \frac{g ( r )}{α ( r )} d r \qquad ( 4 )$$

In equation (4), g(r) is the probability density function of the distance from the target to the centre of the interrogation field, representing the randomness of the target positions. The CV can be distorted from the intrinsic CV due to this fact.

In order to reveal information of the intrinsic distribution, either α(r) is required to be a constant across the interrogation field, which suggests constructing uniform profiles of excitation power and photon-collection efficiency over the entire interrogation field. Additional optics are required, e.g. for Köhler illumination, to realize uniformity, however, this may be at the cost of detection sensitivity. Alternatively, the following condition needs to be satisfied:

g(r)=δ(r−r₀),

r₀ε[0,R_{F}] (5)

δ(•) in equation (5) is Dirac delta function. Equation (5) means all targets appear no more randomly in the field, but only at positions to which the distances from the centre are constant. According to the sampling property of Dirac delta function, it can be obtained:

$${f}^{′} ( i ) = \frac{1}{{α}_{0}} f ( \frac{1}{{α}_{0}} ) , {α}_{0} = α ( {r}_{0} ) \qquad ( 6 )$$

In the example orthogonal scanning method, the targets can be localizing during continuous translation at an identical position, namely the centre of the field. Thus, equation (5) is satisfied, leading to the equality between f′(i) and f(i) (the difference of the scaling factor α₀ is removed when the probability density function is normalized). This demonstrates that the intrinsic distribution of luminescence intensity can be directly acquired via the scanning process. The identical position does not necessarily coincide with the spatial centre of the interrogation field; as a matter of fact, any consistent offset should have no effect on the intensity distribution. There are other possibilities to calculate the positions of targets, not only limited by using the entrance and exit positions. For example, any target positions could be determined by where targets have their highest intensity (i.e. maximum position on intensity profiles). That is, determining the precise position of the target in the first direction can be based on an intensity signal of an identified target.

### Preparation of Example Test Samples

Two example targets were used to demonstrate application of the method, although as previously mentioned a wide variety of targets can be utilized. Two types of europium-containing microspheres were evaluated: the 5-μm diameter FireRed™ microspheres (from Newport Instruments) and the 1-μm diameter FluoSpheres® microspheres (F20882 from Molecular Probes). For each type of target, the original suspension was diluted with deionized water, and subsequently mixed 1:1 with 2.5% polyvinyl alcohol (PVA). Every 10 μl sample from the mixture was smeared onto a cover slip, spin-coated for 60 seconds at 800 rpm, and sealed upside-down onto a microscopic slide with nail polish. Each slide sample contained approximately 100˜150 microspheres.

To further demonstrate the super-sensitivity of the method and/or the system/device, a new evaluation method was developed based on single particle sorting via flow cytometer (for example the FACSAria™ flow cytometer from BD Biosciences). The population of the 1-μm microspheres running through the flow cytometer was identified in a forward scattering versus side scattering plot. For one sample slide, 36 events within the population were sorted individually onto thirty six particular positions, following a predesigned “MQ” pattern (an abbreviation of the Applicant's name).

The performance of the scanning method and example system/device was also evaluated by detecting Giardia lamblia, a protozoan parasite infecting human intestines. Suspended Giardia cysts (6˜9 μm in diameter, 10⁵ in 18 μl, BTF-bioMérieux) were immunofluorescent-labelled with a highly luminescent europium chelate BHHCT-Eu³⁺ according to known protocols. After centrifugal washing away of excessive reagents, the suspension containing labelled cysts was mixed 1:1 with 2.5% PVA solution before taking every 5 μl to smear over microscopic slides, on which cover slips were subsequently placed.

### Accuracy of Intensity Measurements

As a result of the improved high optical uniformity, an intensity coefficient of variation (CV) was achieved as low as 8.4% on the example 5 μm microspheres (FIG. 7c). This result indicates the on-the-fly continuous scanning approach is superior to a step-by-step scanning mode by a significant improvement in CV (which has been reported as 27% being achieved).

### Detection Limit

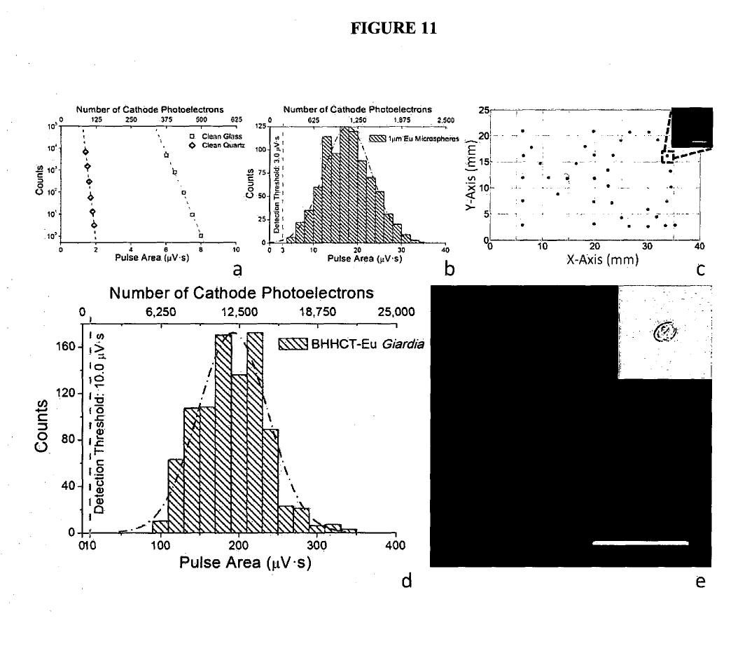

The detection limit is defined by the minimum requirement of the luminescence signals from targets against background noise. To challenge this important parameter, the example system was analyzed as follows. The TGL technique has suppressed almost all the scattered stray light and sample autofluorescence. It was also technically feasible to remove electronic noise from the signals because the electronic noise was random in time rather than an exponential decay profile. The majority of noise should come from the long-lived visible luminescence from the UV-LED and the long-lived luminescence from slide glass impurities. The latter was also quantitatively investigated as represented in FIG. 11a where quartz substrates (for example slides Part No. FQM-7521, cover slips Part No. CFQ-2550, from UQG Optics) generate only as low as 123 photoelectrons, four times better than normal microscopy slide glass (1.97 μV·s, compared to 8.03 μV·s) in the example system. This allowed a further challenge to detect 1-μm europium microspheres (for example FluoSpheres® F20882, from Molecular Probes). By setting an extremely low but confident threshold at 3.0 μV·s, 100% recovery rate of 1-μm europium microspheres was achieved using on-the-fly scanning. As shown in FIG. 11b, the mean area value and standard deviation were 17.7 μV·s and 5.4 μV·s, leading to 30.5% CV. The intensity histogram peak has a signal-to-background ratio (SBR) of 8.9, only requiring around 1,100 photoelectrons in the example system. This number was used to calculate the europium concentration within the 1-μm microsphere resulting in approximate 3.1×10⁴ europium ions.

### Interpretation of Luminescence Intensity

An area A integrated from the acquired TGL signal can be converted to the number of cathode photoelectrons generated in that TGL cycle. It is explicit that:

A=∫ₜ_{₀}^{t}^{₀}^{+T}^{_{WV}}(t)dt=G_{T}G_{E}N_{E}e (7)

In equation (7), N_{E} and e denote the number of cathode photoelectrons and the elementary charge, respectively. Because the transimpedance gain G_{T} and the electron amplification gain G_{E} are predetermined, and e is a constant, A is proportional to N_{E}, which is marked on the upper scale in FIGS. 7c, 11a, 11b and 11d. In particular, an area of 1 μV·s was equivalent to 62.5 photoelectrons generated at the photocathode of the PMT.

To determine the detection limit, clean sets of glass as well as quartz substrates were scanned as control samples, with extremely low level of threshold A_{T}. The false-positive artifacts were deliberately recorded, which appeared at certain A_{T} and the total number soared notably as A_{T} further reduced (FIG. 11a). Conversely, the trends indicated that the probability of false-positive errors decreased exponentially as the threshold rose. The highest area value of artifacts detected on glass substrates was 8.03 μV·s, while on quartz substrates it was 1.97 μV·s. Therefore, it was inferred from the control experiments that the background levels were 502 photoelectrons for glass substrates and 123 photoelectrons for quartz substrates collected during each 100 μs signal window. Since the only difference between the two experiments existed in the substrate materials, the additional noise of 379 photoelectrons was attributed to the rare-earth luminescence from the microscopic glass substrates. The remaining 123 photoelectrons arose from the visible luminescence from UV LED, which primarily limited the sensitivity of the prototype scanning system.

The results on 1-μm microspheres showed their average area of luminescent intensity was 17.7 μV·s, which was equivalent to N_{E}=1,106 photoelectrons generated at the cathode of the PMT detector. Taking account of the quantum yield of the PMT photocathode η_{Q} and the spatial collection efficiency of the objective η_{C}, the number of photons emitted within one TGL cycle from single microsphere N₀ could be further estimated according to the following relationship:

N_{E}=η_{Q}η_{C}N₀ (8)

On one hand, it was calculated for the current PMT module that η_{Q} equaled 15.0% from the cathode radiant responsivity R=75 mA/W at emission wavelength λ=620 nm. On the other hand, assuming the luminescence was isotropic, η_{C} was inferred to be 23.7% based on objective NA=0.85. Thereby, the average N₀ for 1-μm Eu microspheres was approximately 3.1×10⁴. Similarly, the average areas of luminescent intensity from 5 μm Eu-containing microspheres and Giardia cysts labelled with Eu-complex were 197.5 μV·s and 192.0 μV·s, respectively, indicating N_{E}=1.23×10⁴ and N₀=3.47×10⁵ for 5 μm microspheres and N_{E}=1.20×10⁴ and N₀=3.38×10⁵ for labelled cysts.

FIG. 11c shows a recovered 36-dot “MQ” pattern with each dot representing individual 1-μm microspheres. A total number of 10 slide samples were prepared and examined, and 34˜38 microspheres were recovered on the predesigned “MQ” pattern, resulting in 94.4% variation. For samples with <36 hits, each missing spot area was examined with great caution, yet no undetected microspheres were found in the surrounding area. For samples with >36 hits, the system/device returned to the positions of any extra hits, all of which were verified to be the target microspheres. Since all the detected microspheres were at least about three times brighter above the threshold used, these absences were attributed to being missed during flow cytometry sorting. The acquired pulse areas of these flow-sorted microspheres were in evident consistency with the intensity distribution of 1-μm microspheres (FIG. 11 b).

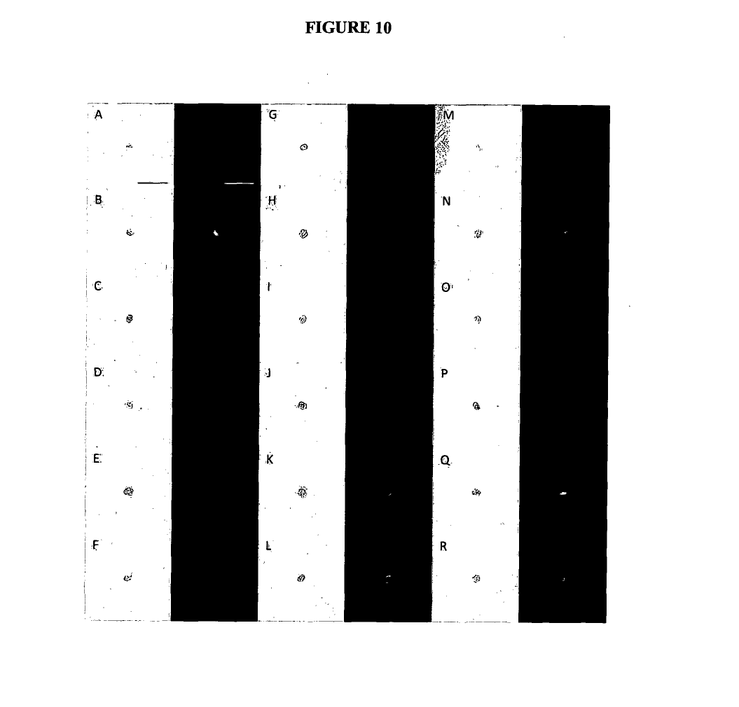

FIG. 9. illustrates the mapping result of one sample slide containing 24 potential Giardia cysts. FIG. 10 illustrates bright-field and luminescence imaging of every target discovered on the sample slide, by retrieving every spot on the mapping result in FIG. 9, to confirm genuine Giardia cysts.

### Analytical Speed

The processing time of each sample varied with the entire area to scan, the size of the interrogation field, and the overall number of targets. The number of targets determines the number of lines to examine in the second stage/direction of scanning, though it does not slow down the first stage of serpentine or raster pattern scanning. The right number of continuous translations in the serpentine or raster pattern also relies on the interval between adjacent lines, which is selected in accordance with the diameter of the interrogation field and the overlap engaged to avoid omission of any targets. If the overlap is too small, the chance of potential overlooking is high, since some targets may pass by the interrogation field near its margin; while excessive overlap is a substantial trade-off for scanning speed. About 0.25˜0.5 of the diameter of the interrogation field is believed to be an appropriate overlap, optionally 0.29 (=1−1/√2) was selected. A mask could be inserted in the detection path, to block the overlapped part to be repeatedly analysed. For example, this could be used to change the shape of interrogation field into a square, or any other desired shape. The mask should also reduce variance when a multi-element detector is used. Under this configuration, the processing time to scan each sample slide was typically around three minutes.

This significant acceleration (compared to 47 minutes in a reported step-by-step method) in scanning speed with enhanced sensitivity and scanning accuracy brings the time-gated luminescence technique to a highly practical approach for high speed cell analysis. In practice, this speed could be further improved to about one minute by implementation of a new-generation motorized stage with faster translation velocity (for example the MLS203-1 model from Thorlabs, having maximal translation velocity 250 mm/s).

### Biological Demonstration

FIG. 11d recorded a confident 100% recovery (CV 23.2%) of a total number of 920 Giardia events from seven sample slides with an averaged signal strength of 192.0 μV·s (equivalent to 3.4×105 europium complex per labelled cysts), and weakest signal strength of 96.3 μV·s, which is still 48 times of the minimal detection limit. Due to the precise localization of microorganisms, each Giardia event can be retrieved for bioimaging as shown in FIG. 11 e. The mapping and imaging results of a typical slide sample bearing 24 labelled Giardia cysts are shown in FIGS. 9 and 10. The distinctive signal-to-background ratio in FIG. 11d suggests absolute detection of Giardia cysts free of false positive and negative errors.

Applying an “on-the-fly” scanning method to time-gated luminescence (TGL) detection significantly unlocks a time-resolved detection constraint requiring long enough signal accumulation time for microsecond-lifetime luminescence detection. The general two-directional scanning method also opens up a new opportunity to achieve background-free biosensing of microorganisms in a high-speed manner. While traditional analysis gives rise to a concern that the lanthanide-based TGL techniques should typically require long enough signal accumulation, on the contrary, the Applicant has demonstrated that the low background level can sufficiently distinguish a TGL signal as weak as 123 photoelectrons per 100 μs (detection limit) in the example system/device used.

Such a short period of detection window fully supports “on-the-fly” detection to significantly accelerate the scanning speed with high target positioning accuracy.

### Upconversion Technique

In another example, the two-directional scanning method can be applied to or utilized with an upconversion technique for luminescence microscopy. The upconversion technique is another technique used to suppress background. Upconversion biolabels can be excited by near-infrared (NIR) radiation in the optimum transparency window of biological tissue, and produce visible multi-colour emissions. This NIR illumination does not excite the non-target materials, and makes it possible to avoid autofluorescence background which otherwise is a major challenge in conventional fluorescent labelling under UV or visible excitation. Thus, the two-directional scanning method can be used with upconversion biolabels able to be excited by near-infrared radiation as the interrogation wide-field.

For the general two-directional scanning method, there is scope to further improve results by modifications to the example system/device presented here, for example to lower the detection limit through UV laser excitation, to improve the CV through linear encoders and autofocus optics, and to accelerate the speed through a faster scanning mechanics. This also provides an opportunity to expand the current spectral domain fluorescence techniques, where typically three to four colours are limited due to a spectral overlapping issue. To achieve high-speed multi-colour fluorescence cell analysis, one now may apply at least four more practical colours in the time-gated domain, for example europium at 610-630 nm, terbium at 470 nm-490 nm and 530-550 nm, ruthenium at 550 nm-700 nm, and platinum at 660-740 nm, thus providing up to eight practical colour analysis options. This provides highly practical and broad sensing applications such as environmental sensing, pharmaceutical development and clinical diagnostic.

### Resolving Low-Expression Cell Surface Antigens Using TGL Scanning Cytometry

Cell surface biomarkers are increasingly recognized as important indicators in cancer diagnosis. For example, the prostate-specific membrane antigen has been found to elevate in malignant prostatic epithelium. Mesothelin, a 40-10 cell-surface glycoprotein, is over expressed in tissues of epithelial ovarian cancer. Flow cytometry, capable of analysing single cells in high throughput fashion, was firstly introduced for detecting cell surface antigens. However, it remains challenging to differentiate weak signal fluorescence from autofluorescence backgrounds, when there are only low abundance surface antigens expressed on cells. The autofluorescence backgrounds mainly come from fluidics, optics, and cellular molecules, generating fluctuating baseline, which makes it difficult or impossible to read absolute signal levels from individual single cells.

On the other hand, time-gated luminescence (TGL) bioassays using luminescent lanthanide (mainly Eu³⁺ and Tb³⁺) bioprobes can be utilised. The microsecond time-resolved luminescence measurement can effectively eliminate the short-lived autofluorescence backgrounds from the raw biological samples or scattering from nearby optics, to provide highly sensitive detections for the analytes, achieving a detection limit of a factor of more than two orders of magnitudes. This approach can be used to image the low-expression surface antigens.

The Applicant used a technique to maximize the signal-to-background ratio and demonstrate a new cytometry platform capable of resolving low-abundant cellular surface antigens from rare event cells. In order to evaluate the technique, CD34 transfected HEK293 cells expressing medium and low level of CD 34 antigens were engineered. The transfection efficiency was tested by flow cytometry using conventional labelling of biotinylated anti-CD 34 antibody and Streptavidin-PE dyes. In order to resolve the population of low-CD34 cells, the next approach applied was to amplify the europium signal strength by europium-complex-rich nanoparticles. Two different sizes (40 nm and 200 nm in diameter) of nanoparticles were tested on the mid CD34⁺ cells, and achieved 3.1 and 20 times enhancement over the europium complex respectively. Both the Zeta potential measurement and Gel Electrophoresis can monitor the conjugation process on nanoparticles from highly negatively charged carboxyl surface to slightly positively charged SA surface in pH 6 solution.

In order to provide statistical cytometry data, the two-directional scanning method was used in combination with time-gated luminescence scanning cytometry to process whole slides of labelled cells. Since an anti-phase sequence of pulsed excitation and time-delayed detection is employed, a single-element photomultiplier tube (PMT) detector only recognizes long-lived europium luminescence, so that points of interest can be rapidly identified using an interrogation wide-field and wide-field microscopy optics. Application of a two-directional orthogonal scanning method accurately identified and brought the target cells into the middle of the interrogation wide-field, so that the maximum intensities of target cells can be recorded with improved or optimal co-efficient of variation (CV) performance.

Using such a method and associated system, the control of HEK293 cells alone were invisible, and only the negative stain control cells (non-transfected HEK293 cells, but stained with anti-CD 34 antibody and SA-BHHCT-Eu, or SA-200 nm Eu nanoparticles) resulted in false positives due to non-specific bindings. The weak signal by BHHCT-europium labelling could only resolve about 28.4% (better than SA-PE flow cytometry results of about 19.4%) of the targeted cells out of the non-specific binding region, and the labelling of SA-200 nm europium-containing nanoparticles successfully resolved the population of CD 34 low-expression cells (about 98.6%). This confirmed another advantage of using the nanoparticles as they did not correspondingly enhance the intensity of non specific binding population comparing to the result by europium complex labelling. A possible explanation might be attributed to lower random binding kinetic behaviour for nanoparticles.

The wide-field optics (for example 75 μm diameter) may increase the chance of doublet or triplet events occurring, which distorts intensity variations. This problem can be overcome by retrieving functions after rapid scanning (a scanning time might be a couple or a few minutes, in one example about three minutes, per slide, depending on slide dimensions). Considering the fact that size variation of each target cell may also introduce additional intensity variation, one can subsequently fit each cell image into intensity vs. area analysis by image. Doublets and triplets can be recalculated into a new singlet-only histogram. Thus, a retrieving function is a useful tool to optimize data accuracy for single cell population analysis.

This example demonstrates application of a two-directional scanning method and TGL to resolve the population of low-expression CD34 cells, which otherwise were not distinguishable in conventional flow cytometry due to the autofluorescence background and fluctuations from one cell to another. Time-gated luminescence detection is applied to suppress the autofluorescence and scatterings, and functionalized polystyrene nanoparticles were employed to amply the signal strength (up to 20 times), which achieved high signal-to-background contrast and successfully resolved low-expression CD34 cells. This technique is compatible with the two-directional scanning and time-gated luminescence scanning method, and resulted in confident statistical data showing a separated target cell population (about 98%) from stain control cells with an optimized CV of 25%. This indicates not only that the new two-directional and time-gated luminescence scanning cytometer can selectively scan and identify rare-event target cells, but also that absolute intensity reading and quantitative analysis of cell surface molecules has been enabled. This confirms the technique can be used as an ultra-sensitive tool for early stage biomarker diagnosis.

### Time-Resolved Scanning: Biodetection in the Temporal Domain

A fast fitting method has been developed based on successive integration to be a suitable method for rapid computation of luminescence lifetimes in the microsecond region, and implemented into a time-resolved scanning cytometry to realize lifetime discrimination in real time or “on-the-fly”. The Applicant found the precision of this method sufficiently approaches the theoretical limit constrained by the Cramér-Rao inequality, while the performance of the method and calculation speed is substantially increased compared to other known fitting methods or algorithms.

The Applicant investigated methods of lifetime computation and differentiation by comparing three fast fitting computer-implemented methods alongside the traditional Maximum Likelihood Estimation (MLE), which delivers the highest accuracy achievable in theory indicated by the Cramér-Rao Lower Bound (CRLB). Critical measurement conditions were determined, and acceleration approaches were proposed to ensure rapid computation of lifetime parameters with sufficient precision. The method was implemented on a prototype system of time-resolved scanning cytometry. In general, fluorescence lifetime measurement can be performed either in the time domain using pulsed excitation, or in the frequency domain using modulated excitation, followed by extraction of a lifetime parameter from the recorded emission waveform.

### Detection System

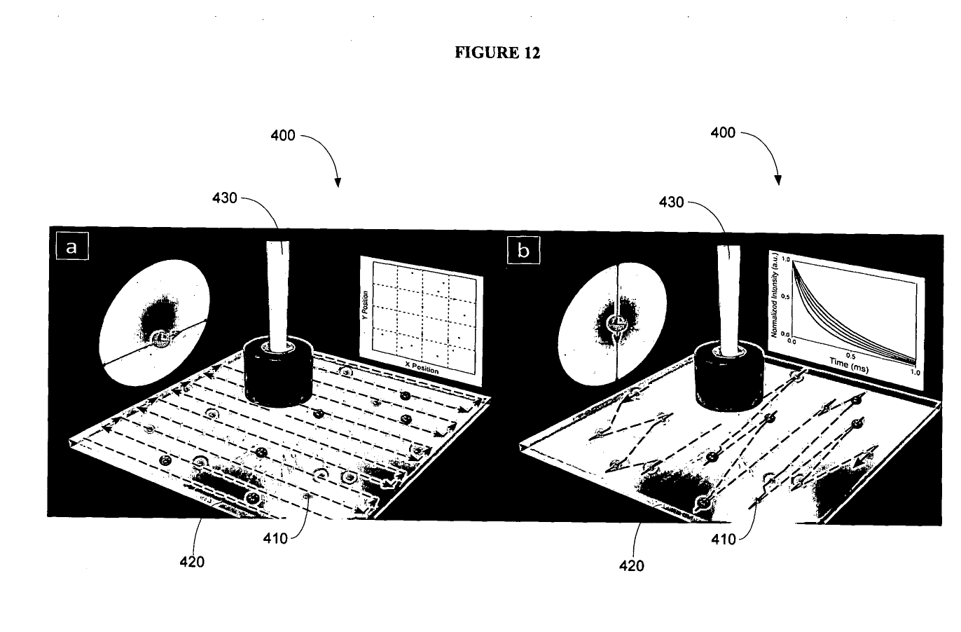

FIG. 12 shows a schematic diagram of an example time-resolved scanning cytometry system 400. To identify any randomly distributed biotargets 410 labeled with long-lived luminescent probes, and to measure individual lifetimes, the time-resolved scanning cytometry system 400 first performs a rapid raster/serpentine scan on a sample 420, for example a microscopic slide sample, with continuous motion of an interrogation wide-field 430 along an X-axis (represented in FIG. 12a by the dotted lines), during which time-gated detection after pulsed excitation discovers all biotargets containing luminescent probes/targets due to a sharp contrast against the background in the temporal domain. During the next phase, Y-axis scans are performed and are more selectively directed to the identified biotargets only (represented in FIG. 12b by the dotted lines), recording luminescence decay profiles during transition for the purpose of computing the lifetimes of individual targets in real time. A lifetime fitting method/algorithm implemented as part of the system is explained below.

### Time-Resolved Scanning Cytometry

Time-resolved scanning cytometry shares the same optical and electronic configurations as for the two-directional scanning method/system. The system was modified on an epi-fluorescence inverted microscope (Olympus IX71) to comprise an ultraviolet light-emitting diode (UV-LED) (NCCU033A, Nichia) and a dichroic filter (400DCLP, Chroma) to excite the sample slide placed on a motorized stage (H117, Prior Scientific) through an 60× objective lens (NT38-340, Edmund Optics). The luminescence signals from the sample were collected by the same objective, split from the excitation optical path by a dichroic mirror, transmitted through a band-pass filter (either FF01-607/36 for Eu³⁺ luminescence or FF01-560/14 for the reporter fluorescence, both from Semrock), and finally collected by an electronically-gatable photon-counting avalanche photodiode (SPCM-AQRH-13-FC, PerkinElmer). The converted electronic photon counts were acquired by a computer at a sampling rate of 500 kHz through a multifunctional data acquisition device (PCI-6251, National Instruments), which also generates synchronized control sequences for time-gated detection as well as stage scanning.

The time-resolved scanning cytometry integrated the lifetime measurement function based on a Method of Successive Integration algorithm and data binning, which were verified by experiments to be appropriate for rapid and robust lifetime computation, especially with data curves superimposed by noise. The period of time-gating cycles was set to 4 ms, consisting of 90 μs excitation pulse, 10 μs time delay, and 3900 μs detection window. The recorded luminescence decay curves were processed by a purposely-built Labview program in real-time to calculate the lifetimes for individual luminescent targets identified on the slide sample.

### Analysis—Overview

From a statistical point of view, after an excitation pulse, luminescence probes emit photons at time series which obey a nonhomogeneous Poisson process with an exponential function as its rate parameter. The Cramér-Rao inequality of estimation theory indicates that the lowest possible variance of any unbiased estimator (called Cramér-Rao Lower Bound, CRLB) is given by the inverse of the Fisher information matrix. In practice, the decay profiles are typically recorded as discrete waveforms consisting of the counts of luminescence photons collected at M equidistant intervals (channels) of T. For simplicity, assuming that the luminescence profiles are monoexponential decays absent of dark noise, the CRLB for lifetime τ can be explicitly derived.

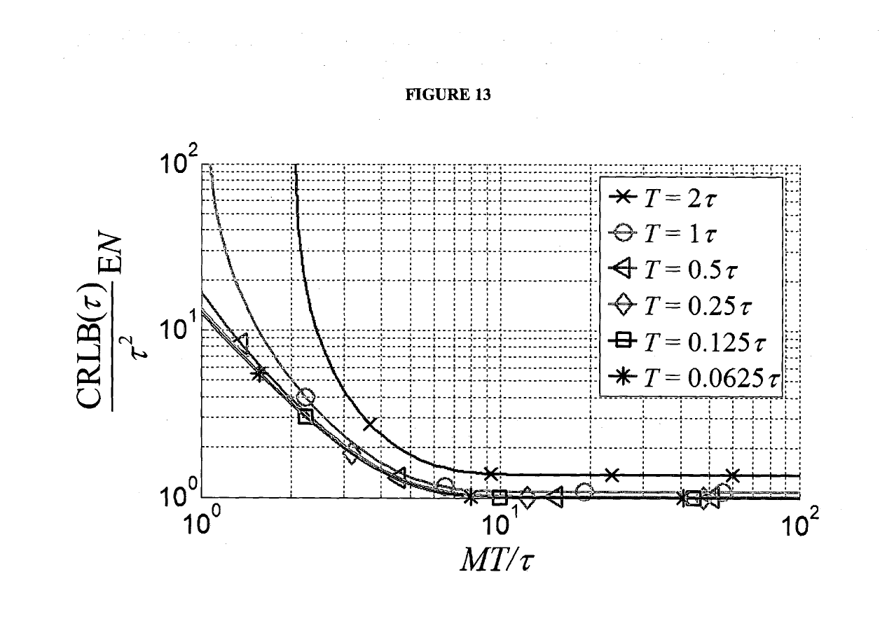

FIG. 13 illustrates the relative CRLB normalized by the signal intensity (the expected value of the total number of luminescence photons N) as a function of MT/τ for different channel widths T. Note that it approaches unity under ideal conditions, which is a feature of the Poisson process. On one hand, since MT is the entire length of the detection window, these curves indicate an important condition for accurate measurement of lifetime: the detection window should be sufficiently long compared to the lifetime under test. Preferably, a duration of a detection window is at least eight to ten times a lifetime of interest. Otherwise, if the window duration is only about the lifetime under test, the variance in the final results will be at least ten times larger than its genuine value, since no algorithm can achieve a better variance beyond CRLB. On the other hand, the curves with channel width T smaller than half of the lifetime τ are almost identical to each other, indicating that subtle sampling at high frequency does not necessarily improve the precision of lifetime measurement. On the contrary, this suggests that the lifetime computation may be accelerated without sacrificing precision, simply by reducing the channel number through data binning.

### Numeric Simulation to Compare Lifetime Fitting Algorithms

The Applicant verified the analysis using numerical simulation with four prevailing lifetime fitting methods/algorithms. The first method was nonlinear fitting based on maximum likelihood estimation (MLE-NF), which has been suggested as the most accurate algorithm to estimate parameters from exponential decay. The second method (MLE-PR) was a pattern recognition technique based on Kullback-Leibler minimum discrimination information, which is an enumerative imitation of the MLE-NF. The third was the Rapid Lifetime Determination (RLD) method, which has been applied due to its great simplicity. The fourth was the Method of Successive Integration (MSI), which has attracted interest after it was proved to be superior to another popular fast algorithm of Fourier transform. The aim of this comparison is to determine the best algorithm among the last three (MLE-PR, RLD and MSI) in terms of accuracy and speed. The traditional MEL-NF provides an informative reference when comparing the accuracy; however, it is unlikely to compete for a robust rapid method due to the nature of nonlinear fitting (massive computation complexity, sensitive to the selection of initial values and constraint conditions), whereas the computation processes for other methods are linear.

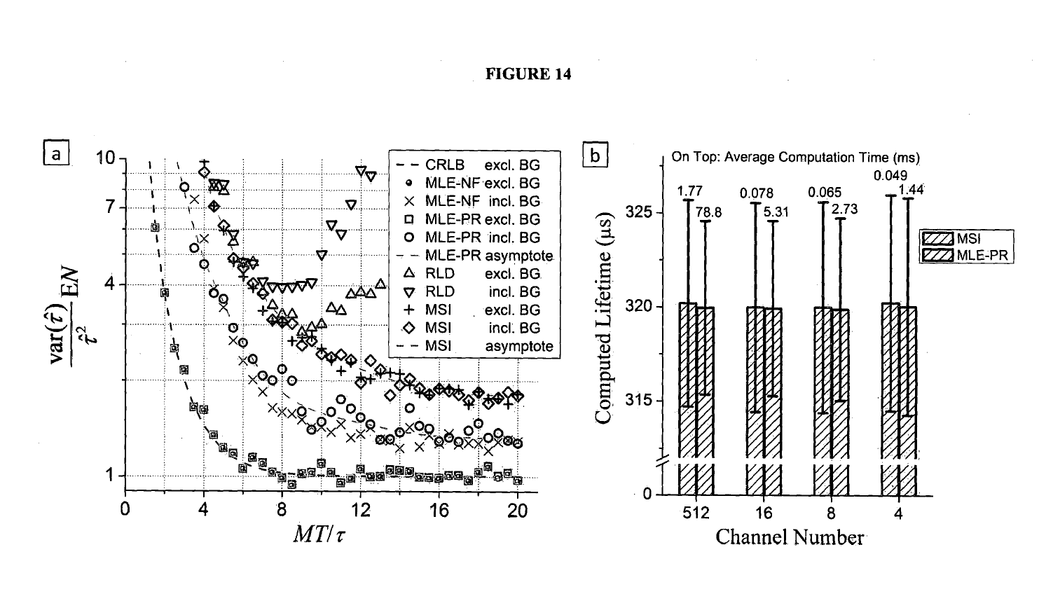

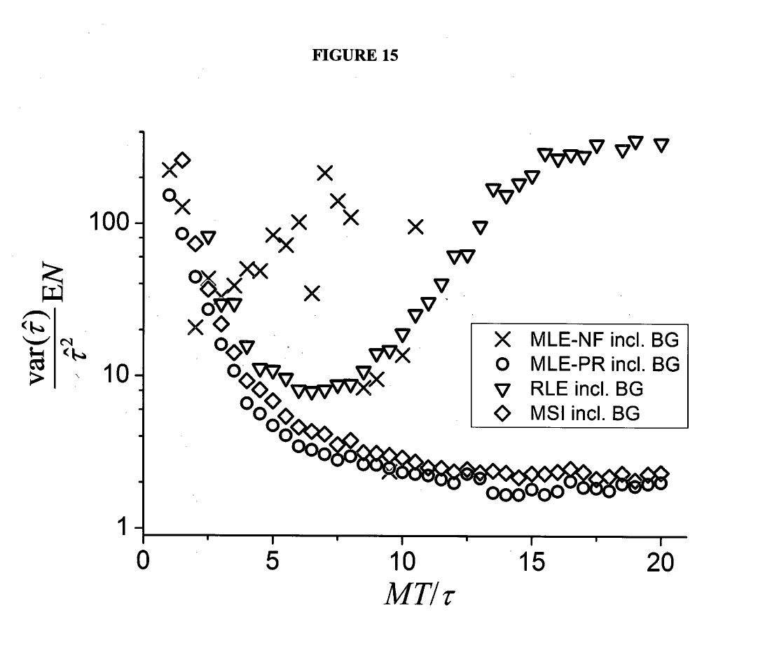

Poisson processes for a time series of a total number of 10,000 of the luminescence photon counts are generated from 10,000 random numbers chosen from the exponential distribution with mean parameter of a true lifetime value 320 μs. The time series were counted within M adjacent channels with all widths equal to T, to obtain a simulated decay curve. A random number chosen from the Poisson distribution with parameter BT (B=10⁵ for FIG. 14 and B=10⁶ for FIG. 15) was superimposed for each channel to simulate the dark counts. For every set of (M, T), the computation via each fitting algorithm was repeated 1000 times, each time with a new decay curve. All simulations were executed by a Matlab program running on a PC computer.

FIG. 14 summarizes the simulation results. In FIG. 14a, when the data curves are free of background noise (consequently no baseline in the exponential function model) the variances of the computed lifetimes through both MLE-NF and MLE-PR attain the CRLB in an asymptotic sense, which means the error of the estimates converge to the minimum value it could ever reach statistically. Although not as efficient as MLE, RLD and MSI are similarly good in the initial part; however, with longer detection window, MSI obtains better precision while RLD becomes inefficient, because the denominator encountered in RLD approaches zero (sometimes even becomes negative if the signal level is low) as the length of the detection window increases. If a background baseline is considered in the model (in this case no close form can be derived for the CRLB), MLE-NF is still the most efficient method. The precision of MLE-PR is very close to that of MLE-NF—the slight inferiority lies in the limited enumeration precision to ensure a relatively high computation speed. RLD maintains the trend but with a higher valley at smaller detection window length. Despite the fact that a few purposely-built instruments have used it to measure long lifetimes, it actually provides inferior results due to inherent deficiency.

To the Applicant's surprise, although the precision decreases for the other three methods as the background noise is involved, MSI always has the same performance. This is because the calculation formula derived in MSI initially takes the baseline into account. In fact, the difference in precision between MLE-PR and MSI becomes very small as the signal-to-background ratio further decreases (see FIG. 15).

FIG. 14b compares the lifetime computation by MLE-PR and MSI with simulated data before and after data binning (true lifetime value was 320 μs). It was clear that MSI is much faster than MLE-PR by about 46 times under identical conditions, to obtain the same unbiased results with variance only about 1.3 times larger. In addition, it was found that for both methods, binning up to ×64 (from 512 channels to 8 channels in total) did not increase the variance obviously, though further binning will clearly reduce the precision. Nonetheless, the computation speed was significantly enhanced by the binning pretreatment.

From the analysis and numeric simulation carried out, the Applicant determined implementing MSI was preferred along with data binning as the best fitting method for the time-resolved scanning cytometry system to measure the μs-to-ms lifetimes of individual luminescent targets almost as precisely as MLE but in a much more rapid fashion.

Two important detection configurations should be emphasized: 1) a duration of the detection window should be sufficiently long, preferably eight to ten times of the lifetime under test for good trade-off between accuracy and speed; 2) providing the channel width not beyond, i.e. less than, the lifetime under test, substantial data binning can be applied to speed up the computation while maintaining same level of precision. Note that although monoexponential decays are assumed here, MSI can be applied to multiexponential cases as well.

The Applicant has demonstrated that luminescence lifetimes in the microsecond regime can be determined in a relatively fast, robust and unsophisticated fashion, using data binning pretreatment followed by, for example, a Method of Successive Intergration (MSI) fitting method/algorithm. To achieve sufficient accuracy, key requirements for the detection configuration should be satisfied that the detection window is of sufficient duration, preferably at least about eight times of the lifetime under test, and the channel width after binning remains smaller than the lifetime under test.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A two-directional scanning method for luminescence microscopy, comprising:
performing a series of scans of a sample by an interrogation wide-field relative to a first direction and identifying a target;
determining a precise position of the target in the first direction; and
performing at least one scan by the interrogation wide-field, relative to a second direction, at or near the precise position of the target in the first direction.

2. The method of claim 1, wherein the target passes through the centre or near centre of the interrogation wide-field for the at least one scan by the interrogation wide-field relative to the second direction.

3. The method of claim 2, wherein a luminescence intensity signal profile for the target, on which subsequent analysis is to be based, is acquired during the at least one scan relative to the second direction.

4. The method of claim 1, wherein scans by the interrogation wide-field use a continuous motion along the first direction.

5. The method of claim 7, wherein determining the precise position of the target in the first direction is based on determining the positions where the target enters and exits the interrogation wide-field.

6. The method of claim 7, wherein determining the precise position of the target in the first direction is based on determining the times when the target enters and exits the interrogation wide-field.

7. The method of claim 1, wherein determining the precise position of the target in the first direction is based on a luminescence intensity signal profile of the target during the series of scans relative to the first direction.

8. The method of claim 1, wherein an approximate position of the target in the second direction is also obtained as a result of the series of scans by the interrogation wide-field relative to the first direction.

9. The method of claim 1, wherein a plurality of targets are identified at a number of precise positions in the first direction, and a series of scans by the interrogation wide-field are performed, relative to the second direction, using the number of precise positions of the targets in the first direction.

10. The method of claim 1, wherein determining the precise position of the target in the first direction accounts for acceleration and deceleration of the sample.

11. (canceled)

12. (canceled)

13. The method of claim 1, wherein the interrogation wide-field is of larger diameter or extent than a characteristic dimension size of the target.

14. (canceled)

15. The method of claim 1, wherein more than one target is simultaneously detected by subdividing the interrogation wide-field into sections.

16. (canceled)

17. (canceled)

18. The method of claim 1, wherein a mask is inserted in a detection path to change the shape of the interrogation wide-field.

19. The method of claim 1, wherein the method provides real time “on-the-fly” (ex tempore or impromptu) scanning.

20. The method of claim 1, wherein the targets are bioprobes or microorganisms.

21. (canceled)

22. The method of claim 1, wherein the two-directional scanning method is used with a time-gated luminescence scanning method including switching on a detector at a delayed time from switching off the interrogation wide-field that is pulsed.

23. The method of claim 22, wherein the time-gated luminescence scanning method uses targets with long-lived luminescence relative to background luminescence.

24. (canceled)

25. (canceled)

26. (canceled)

27. (canceled)

28. The method of claim 1, wherein the two-directional scanning method is used with upconversion biolabels.

29. The method of claim 28, wherein the upconversion biolabels are able to be excited by near-infrared radiation as the interrogation wide-field.

30. (canceled)

31. The method of claim 1, wherein the two-directional scanning method is used with a time-resolved luminescence scanning method and detection is of two or more targets with distinguishable lifetimes, and wherein the two or more targets are luminescent probes having lifetimes in the range of microseconds to milliseconds.

32. (canceled)

33. (canceled)

34. (canceled)

35. (canceled)

36. (canceled)

37. (canceled)

38. (canceled)
